(19) United States
(12) Patent Application Publication
(10) Pub. No.: US 2008/0017432 A1
(43) Pub. Date: Jan. 24, 2008

(54) Recumbent two-wheeled motor vehicle with low center of gravity providing optional elliptical frame rider protection in six degrees

(76) Inventor: John C. Chelen, Washington, DC (US)

Correspondence Address: DORT PATENT, P.C., Box 26219, Crystal City Station, Arlington, VA, 22215, US

(21) Appl. No.: 11/229,006

(22) Filed: Sep. 16, 2005

Related U.S. Application Data
(60) Provisional application No. 60/522,347, filed on Sep. 17, 2004.
(60) Provisional application No. 60/522,334, filed on Sep. 16, 2004.

(51) Int. Cl. B62K 11/02

(52) U.S. Cl. 180/219

(57) ABSTRACT

The present invention demonstrates a high-performance, high-safety, and high-efficiency motorcycle with a desirable recumbent configuration for improved performance and compact wheel base. The motorcycle provides a seat for the driver in front of the engine and both the driver and engine are located as low as possible to the road while permitting sufficient road clearance. The combination of recumbent driver position located within the chassis provides for reduced overall volume of the vehicle while also permitting various protective surrounding members or an envelope body. In one variation, the motorcycle includes at least two at least partial oval structures forming a virtual ellipse, the first at least partial oval structure being formed by part of the rear part of the frame of the vehicle and is positioned such that the plane of the oval is at an angle theta and rising towards the rear of the vehicle, wherein the plane formed by the first structure is normal to a roadway surface, and the axis of the first partial oval rises towards the rear of the vehicle, the rising part at least partially forming a riding platform structure; and the second at least partial oval structure formed by part of the frame of the front part of the vehicle and is positioned such that the plane of the oval is at an angle phi from the road surface and rising towards the front of the vehicle.

### CROSS-REFERENCE TO RELATED APPLICATIONS

This patent application claims priority under 35 USC §119(e) and other international and national provisions to U.S. Provisional applications 60/522,347 filed on Sep. 17, 2004 and entitled RECUMBENT TWO-WHEELED MOTOR VEHICLE PROVIDING RIDER PROTECTION IN SIX-DEGREES, and U.S. Provisional Application Ser. No. 60/522,334 filed Sep. 16, 2004, and titled RECUMBENT TWO-WHEELED MOTOR VEHICLE PROVIDING RIDER PROTECTION IN SIX-DEGREES, both of which are incorporated by reference in their entirety for all purposes.

### BACKGROUND OF THE INVENTION

This invention relates in general to motorcycles, and more particularly to a new geometric relationship of rider to engine and chassis, as well as a set of performance and protective devices and configurations.

Motorcycle chassis designs are derived from a horse-and-rider configuration. That is, the rider rides above the motorcycle in the same way a rider rides upon a horse. Although this does provide certain advantages, it negatively causes a large frontal area and excessive wind resistance, as well as a high center-of-gravity. Alternately, in a manner similar to an automobile, the rider should be placed within the motorcycle chassis. This would reduce frontal area and lower the center-of-gravity, as well as afford several options for encapsulating the driver with various protective and streamlining devices.

Motorcycles are well-known to be hazardous vehicles. Having only two wheels, they are not as stable as vehicles with four wheels. The center-of-gravity is relatively high compared to other types of vehicles. Also, the motorcycle does not have an outside body and consequently offers no protection to the rider in a collision or fall.

In the past, protective cages or shells have been designed to fit over a motorcycle, thereby encompassing the motorcycle rider and offering some type of protection. However, these devices are bulky and heavy, and in this manner tend to impede and restrict the motorcycle driver and impair the performance of the motorcycle.

Motorcycles have incorporated the “feet forward” concept or a reclined rider for decades. See Feet Forward by Tony Foale (1997) in which the history of the “forward-positioned” motorcycle rider is discussed, and is incorporated by reference and included herein in Appendix A. FIG. 19 shows a historical high-speed concept “feet forward” cycle discussed by Foale in his article. One of the problems with this cycle is that it fails to incorporate features that would be required by a cycle riding public, such as a steering column.

Referring now to FIGS. 18A and B, Foale goes on to discuss the advantages and disadvantages provided by the lowered center of gravity in the “feet forward” cycles. He states that”

Most FFs have a considerably lower seat height than possible with a conventional machine. This lowers the CoG and also reduces the roll moment of inertia. In other words the various masses are centralized closer around a longitudinal axis through the CoG. The combined effect is that the bike has better roll-in performance. Initiating a turn is usually a combination of some bodily weight movement and a bit of counter steering. The more secure riding position of some types of recumbent largely eliminates the possibility of shifting the riders weight and so all of the control function must come through steering input, but I don't see this as a problem for normal riding, just a slightly different technique being needed. In any case a lower CoG. means that less effort is needed anyway to provide the roll or leaning movements (we have a lower roll moment-of-inertia). Thus we get a quicker handling machine, which may well more than compensate for the opposite effect from the longer wheelbase.

Another effect of a low CoG is less weight transfer under braking and acceleration, reducing dive and squat. This can lead to improved braking because of the better balanced loads on the tyres. Lets look at some numbers to get a feel for the effects.—Imagine a hypothetical machine, with a 56″ wheelbase and a 28″ high CoG height, and a 50/50 weight bias under static conditions. Then under the action of severe braking, say 1G, all the load on the rear wheel will be transferred to the front, and so the front tyre will be required to bear the total stopping forces. A machine under these circumstances will also be directionally unstable and only the skill of the rider can prevent the inevitable. Now consider a long, low recumbent with a 85″ wheelbase and an 18″ CoG. height. Then under the same degree of braking only 42% of the previous weight transfer will take place. This allows significant rear wheel braking, which if optimally applied would result in better braking. Unfortunately, to exploit this potential the rider must be capable of operating both brakes to their optimum and there are very few riders who can do this. The reduced weight transfer under acceleration will give a more stable machine, but will reduce the available traction thus reducing the maximum force available to accelerate the bike. This is only a problem with high powered machines with more torque at the wheel than can be transmitted to the ground.

It is in side winds that a disadvantage of a low CoG. may be felt. Under the action of a steady breeze the machine must lean into the wind more, in order to balance the wind force. Of course with the FF. layout the lower mounted, body side area may well compensate for this effect, but the side area may well be greater anyway due to increased length and so negate this benefit. With gusty winds I expect that the FF. will be at a disadvantage. Any lowering of the sideways centre of pressure will probably be approximately proportional to the lowering of the CoG, whereas the roll moment-of-inertia will vary approximately as the square of the CoG. height. In other words the bike's resistance to the wind gusts will be decreased more than the disturbing effects from them. This means that the machine will experience greater roll angle changes, roll movements cause steering movements through gyroscopic effects, thus aggravating the situation.

Therefore, a two-wheeled vehicle is needed that is more efficient and safer than the current two-wheeled vehicles or those recumbent cycles discussed in the prior art, but that also avoids impeding the driver and impairing the performance of the motorcycle by encompassing the driver as the prior art does.

### SUMMARY OF THE INVENTION

The present invention presents a high-performance motorcycle with a desirable recumbent configuration for improved performance while maintaining a compact wheel base. The driver is located in a supine position within the overall motorcycle chassis, with the engine located behind the driver. Both the driver and the engine are located as low as possible to the road surface while maintaining sufficient ground clearance for unimpeded travel.

In the simplest version of the invention, a single backbone chassis component connects the engine and the front wheel fork assembly. In such a configuration, the backbone extends forward from the engine beneath the driver and between the driver's legs. The driver's seat is supported either by this backbone or by the engine itself. One of the technical features that allows the supine position motorcycle to be practically used is an optional gyroscopic balancing system which is placed in the structure underneath the riding platform in particular embodiments.

Because of this novel positioning of driver and engine, the vehicle presents a low profile and frontal area, and additionally, provides an optimum configuration for encapsulating the driver with additional structures for safety, performance, comfort, and convenience. In a particular embodiment, the high-performance cycle locates the base of the driver seat on a plane beneath the axles, and in some embodiments below the main components of the engine.

One version of the motorcycle includes two partial oval or elliptical frame structures forming a “virtual roll cage;” the first oval structure being formed at the rear part of the chassis of the vehicle and positioned such that the plane of the oval is at an angle theta and rises towards the rear of the vehicle; and the second oval structure is formed at the forward part of the chassis and is positioned such that the plane of the oval is at an angle phi from the roadway surface and is rising towards the front of the vehicle; this combination of oval structures provides an ability to eliminate the central backbone from the chassis and provides an alternative means of supporting the rider's seat. The elliptical frame model avoids necessarily needing the gyroscopic balancing system, but it is included in particular embodiments.

### BRIEF DESCRIPTION OF THE FIGURES

FIG. 1 illustrates a side angle view of a first embodiment (Suprine Machine Model #1)

FIG. 2 illustrates a side angle view of the first embodiment with an arch support platform and a gyroscopic balancing system;

FIG. 3 illustrates a first embodiment of the invention from a front view;

FIG. 4 illustrates a side view of the invention with an arc spine frame support structure;

FIGS. 5A and B illustrate an embodiment of the invention wherein the spine frame is diagonally shaped;

FIG. 6 illustrates an angled side view of a alternate embodiment of the invention;

FIG. 7 illustrates a side view of a primary embodiment of the invention with a base frame support and an elliptical frame protection system;

FIG. 8A illustrates a top view of a primary embodiment of the invention;

FIG. 8B illustrates a front view of a primary embodiment of the invention;

FIG. 9A is a top angle view of an embodiment of the invention with a model rider having two protective oval structures;

FIG. 9B is a front angle view of the embodiment of FIG. 9A;

FIG. 9C is a top view of the embodiment of FIG. 9A;

FIG. 10A illustrates the operation of the zones of protection in a rotating accident system or x-axis accident;

FIG. 10B illustrates the operation of the zones of protection in a rollover accident system or y-axis accident;

FIG. 10C illustrates the operation of the zones of protection in an end-over-end accident system or z-axis accident;

FIGS. 11A and B illustrate an enhanced oval protective frame embodiment with a bucket seat feature from top and side views respectively;

FIG. 12 shows an embodiment of the invention with both oval and side frame protection systems;

FIG. 13A is a top view of a side frame protection system embodiment with a bucket seat feature;

FIG. 13B is a side view of the embodiment shown in FIG. 13A;

FIG. 13C is a front view of the embodiment shown in FIG. 13A;

FIG. 14A illustrates a rollcage embodiment of the two-wheeled cycle from a side view and including an optional support arm;

FIG. 14B illustrates a rollcage embodiment of the two-wheeled cycle from a rear view;

FIG. 15A illustrates an alternate rollcage embodiment of the two-wheeled cycle from a top view with a bucket seat feature;

FIG. 15B illustrates an alternate rollcage embodiment of the two-wheeled cycle from a side view with a bucket seat feature;

FIG. 16 illustrates a side view of an alternative embodiment of the invention having a full body protective system and having an optional support arm; and

FIGS. 17A and 17B illustrate respective top and side views of an embodiment of the invention that uses a diagonal spine frame for the full body protective system;

FIGS. 18A and 18B illustrate the forces acting in cycles that have normal and lowered centers of gravity; and

FIG. 19 is a sample of a prior art recumbent motorcycle.

### DETAILED DESCRIPTION OF THE INVENTION

With reference to the following drawings, the notation t for functional parts or structures (such as the foot supports) that appear multiple times on the inventive motorcycle, facing forward, parts on the left will be referred to with an “(A)” and parts on the right with be annotated with a “(B)”. For functional parts or structures that may appear, facing forward, from front to back will be referred to in numerical order as “(1) . . . (2) . . . ; (3) . . . ” However, the sub-notations are meant to be illustrative only and should not be construed as any type of limitations on the claims.

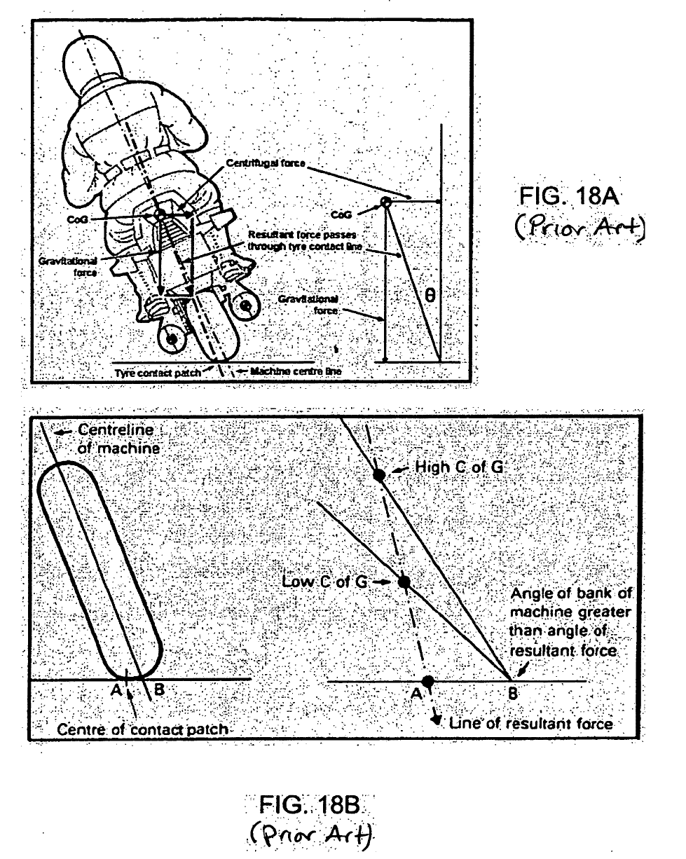

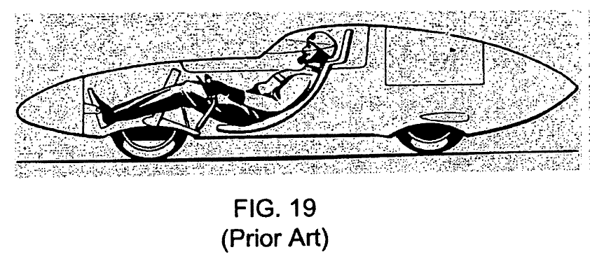

FIGS. 18A and B are descriptions of the principle in which the lowered centered of gravity is used for a recumbent motorcycle. This is discussed more fully above in the background section.

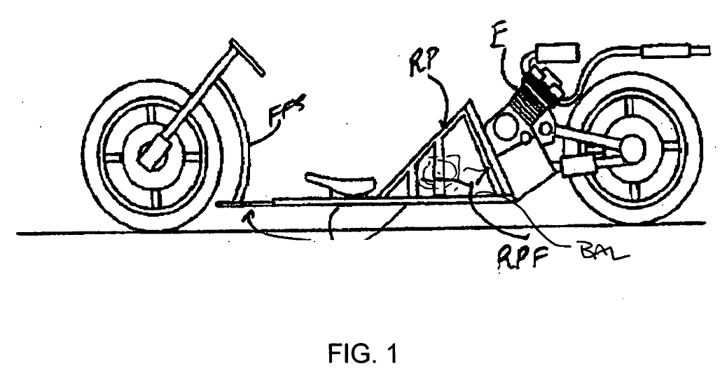

Referring now to FIG. 1, a first embodiment or Suprine Machine model No. 1 arc-spine embodiment of the invention is shown in which a recumbent motorcycle is positioned such that the engine E is partially above the riding platform RP. The base frame “flat spine” of the first embodiment is a long or slightly concave (for strength) member that is partially supported by a front frame support FFS. The riding platform RP, which is a common feature to most embodiments of the invention, may be supported by the riding platform frame RPF.

The optional support platform may be made slightly convex (or concave) to provide additional support without changing the advantageous characteristics of the invention or increasing the wheel base. A support arch angle (SA) may be modified in the end use needs of the inventive vehicle. This feature helps to promote stability, while keeping the center of gravity of the vehicle low enough to keep performance high.

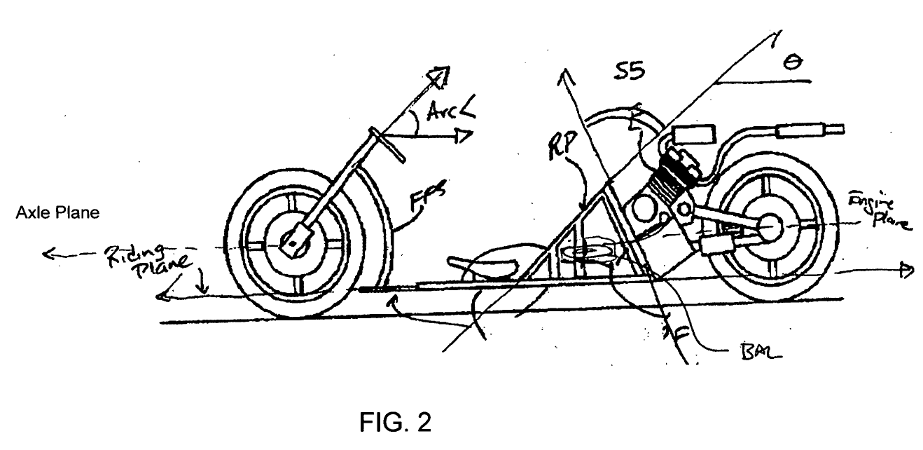

FIG. 2 illustrates the improved high-performance motorcycle's planes and angles as they may be configured in a first embodiment. First, the arc spine FFS is an arc of equivalent to the arc angle (Arc [symbol] ) as it is formed by the intersection of the support platform SP and the steering column SC. Other angles and relative distances that may be considered in the structural configuration of the innovative motorcycle are included in the table

TABLE 1
Angle and Distance Definitions for the Suprine Machine
(Model #1)

| | Description |
|---|---|
| Angle Notation (FIG. 2) | |
| ⊖ | Angle which the riding platform RP is from |
| | the roadway normal. |
| [symbol] S | Angle at which the riding platform structure |
| | RP intersects the front support.. |
| [symbol] Arc | Degree of arc traveled in the arc spine. |
| [symbol] SI | Angle formed by intersection of support |
| | platform to end of arc spine. |
| [symbol] S3 | Steering Column (RO) to z axis. |
| [symbol] S4 | Motor support (MSF) placement angle |
| [symbol] S5 | Engine support platform (ESP) placement |
| Distance Notation (FIG. 2) | |
| RWC-PR | Distance from the roadway to the riding |
| | plane. |
| RWC-AP | Distance from the roadway to the axle |
| RWC-EP | Distance from the engine plane to the |
| | roadway. |
| RWC-SP | Distance from the lower support platform to |
| | the roadway. |
| RWC-Overall | Distance from the lowest point on the |
| | motorcycle to the roadway. |
| PR-AP | Z-axis distance between the plane formed |
| | by the axles parallel to the roadway and |
| | the plane where the driver sits (top of the |
| | seat, not the support). |
| EP-PR | Z-axis distance between the plane formed |
| | by the base of the engine and the plane |
| | where the driver sits. |
| EP-AP | Z-axis distance between the place formed |
| | by the base of the engine and the plane |
| | formed by the axles parallel to the |
| | roadway. |
| WB-A | Wheel base from axle to axle |
| WB | Wheel base from front edge of front tire to |
| | back edge of rear tire or the end of the |
| | exhaust in particular embodiments in which |
| | the exhaust extends beyond the edge of |
| | the back tire. |
| FC | Distance from the placement of the rider's |
| | front feet (estimated) to the front axle. |
| RC | Distance from the anticipated top of the |
| | rear of the rider's head to the rear axle. |

FIG. _2_reflects one of the technological developments that helps to make some of the embodiments of the invention possible. The gyroscopic balancing and steering system which has been incorporated into such products as the Segue™, and is fully described in U.S. Pat. Nos. _{—}6,929,080, 6,915,878, 6,543,564,_{—} 5,975,225, 5,971,091, and 5,701,965_ to Dean Kamen et al, which are fully incorporated by reference for the purposes of teaching the gyroscopic balancing system. Of course, the needs for a two-wheeled recumbent high-performance motorcycle will require different gyroscopic balancing than that of the upright two wheel vehicle, but the principle assisting the rider is similar.

The gyroscopic balancing BAL is generally on required at low speed or while the bike is stationary during stops. Ideally, the gyroscopic system is located in the support/storage structure underneath the rider, SL, which is near the engine and battery, so that power is delivered to the gyroscopic system BAL while the cycle is in motion, which allows the gyroscopic system BAL to not draw on power while the cycle is not generating power when idle.

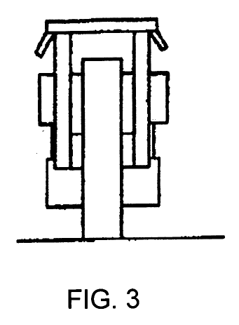

Referring now to FIG. 3, a front view of the sample first embodiment is shown. Other important structural configurations are shown as noted in the table below.

TABLE 2

| Distance Notation (FIG. 3) | Description |
|---|---|
| SWC | Clearance required by the widest points on |
| | the cycle W(A) to W(B) |
| WC-1 | Clearance required by the widest points on |
| | the cycle with the rider in place. |

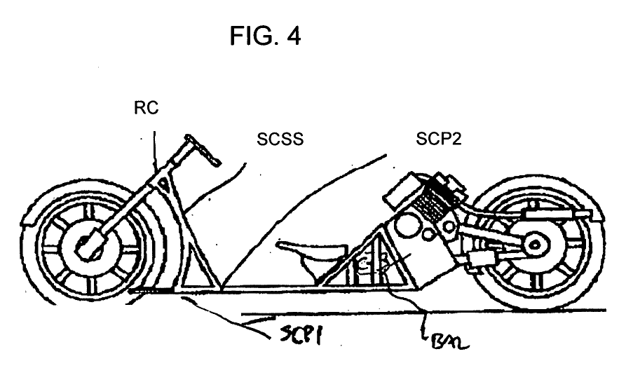

FIG. 4 illustrates another possible embodiment of the inventive motorcycle (or Suprine Machine™ model No. 2), in which the spine arc FPS is configured to be supported by a straight support structure SCSS connected to the steering column merging with the arc spine AS and then continuing to the support platform SCP1 at support point SCP2. The fusion of the arc spine AS and the straight support structure SCSS forms two smaller triangular support forms TSF(1) and TSF(2). The spine may extend beyond the support contact point SCP, for functional and cosmetic purposes. The plane on which the rider sits or rider base (PR) is lower than the engine plane (EP) than in the first embodiment described above, but is not much closer to the axle plane (AP) and can vary from configuration to configuration depending on the end-user requirements.

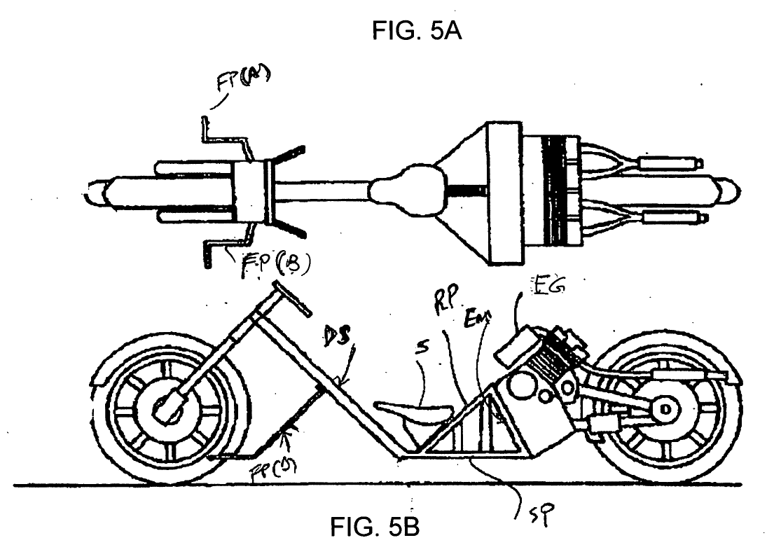

FIGS. 5A and 5B show top and side views of a supported diagonal spine frame embodiment of the invention (or Suprine Machine Model #3). In this embodiment a diagonal spine DS extends downward from the steering column (not labeled) to meet the support platform SP at a point MP near the low point of the riding platform RP at a support intersection point IP. The riding platform RP in this embodiment is generally much shorter than in the arc spine embodiments discussed above in FIGS. 1-4. Optional foot placement supports FP(A) and FP(B) can be connected to the diagonal frame DS.

As also can be seen in the diagonal spine frame embodiment in FIGS. 5A and B, the plane on which the rider sits (PR) is not necessarily below of the axle plane AP or the engine plane EP, like it is in the embodiments described above. However, as the illustration shows the structure that supports the weight of the rider which is near the support intersection point IP has a plane below that of the axle plane AP and the engine plane EP.

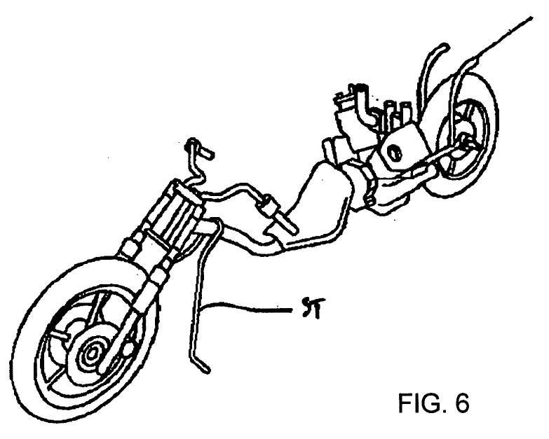

FIG. 6 shows an alternate embodiment of the “bare frame” model or Suprine Machine™ Model #4 from a top-side view. The spine SPE extends to the support platform SP from the steering column SC. An optional stand ST may fold into the spine SPE or simply retract. The particular embodiment shown shows the cycle seat option as well, which may be preferred by high-performance riders. The riding plane PR sits below both the axle plane AP and the engine plane EP, keeping the center of gravity on the bike very low to the ground. It should be noted that the embodiment shown does not include some optional safety features. For example, to reduce the weight of the cycle, there is no barrier between the engine and the upper portion of the rider. Without such safety features, design features such as engine type and placement are more critical.

The embodiment shown in FIG. 6 also illustrates the present invention as it may take advantage of high-performance (and light weight) materials that allow the spine SPE to support the weight of the rider and some of the weight of the engine. For example, composites may take the place of alloys in the construction of the cycle without compromising safety or performance.

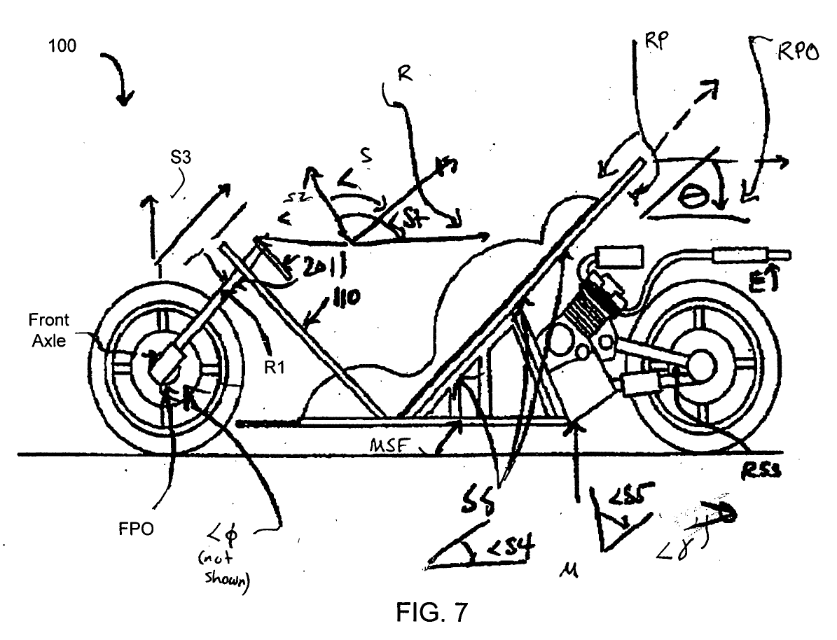

FIG. 7 illustrates a front view of a primary embodiment of the invention or Suprine Machine model #5, a dual elliptical frame embodiment with support platform enhancement. In this embodiment, a structure that forms a partial or “virtual” oval, RPO, is generally formed by part of the rear part of the frame (not labeled, can be comprised of multiple parts) which rises at an angle theta (Θ) from the plane formed by the first structure and is usually normal to a roadway surface. The “axis” of the partial or virtual oval (which may be considered the riding platform structure for illustration purposes) rises towards the rear of the vehicle. The rising part partially forms a riding platform structure RP. The second partial or virtual oval structure FPO is generally formed by the front part of the frame (not labeled), and is positioned such that the plane of the oval/ellipse is at an angle phi (φ) from the road surface and rising towards the front of the vehicle.

| Angle Notation FIG. 7 | Description |
|---|---|
| ⊖ | Angle which the riding platform RP is from |
| | the roadway normal. |
| φ | Angle at which the front protection |
| | structure extends out from the z-axis. |
| [symbol] S | Angle at which the riding platform structure |
| | RP intersections the front support (110). |
| [symbol] S+ | Front support (110) to rear normal plane. |
| [symbol] S2 | Front support (110) to front normal plane. |
| [symbol] S3 | Steering Column (RO) to z axis. |
| [symbol] S4 | Motor support (MSF) placement angle. |
| [symbol] S5 | Motor (M) placement angle. |
| [symbol] S6 | Rear drive structure protection RSS angle. |

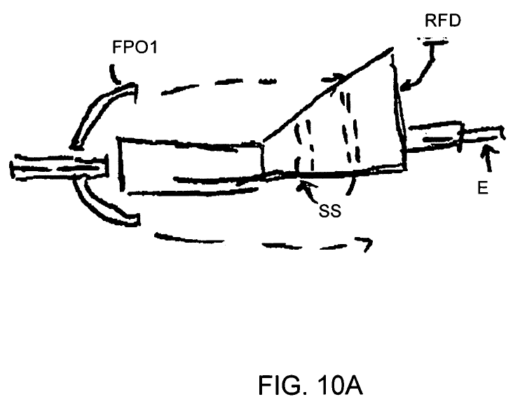

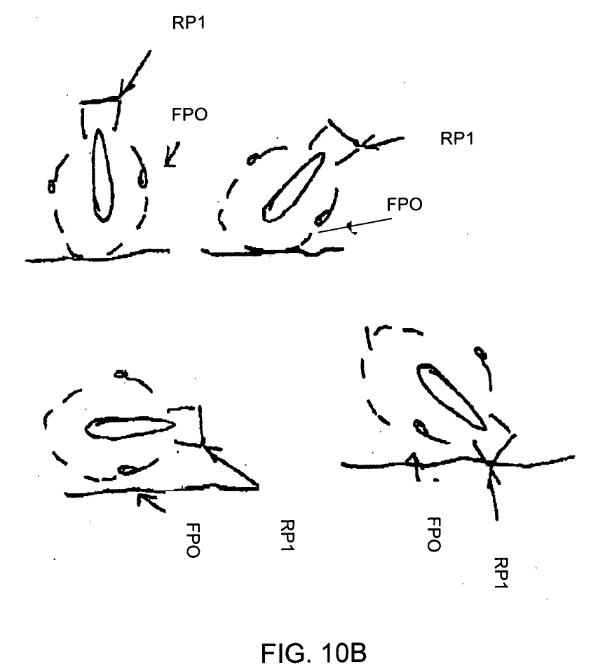

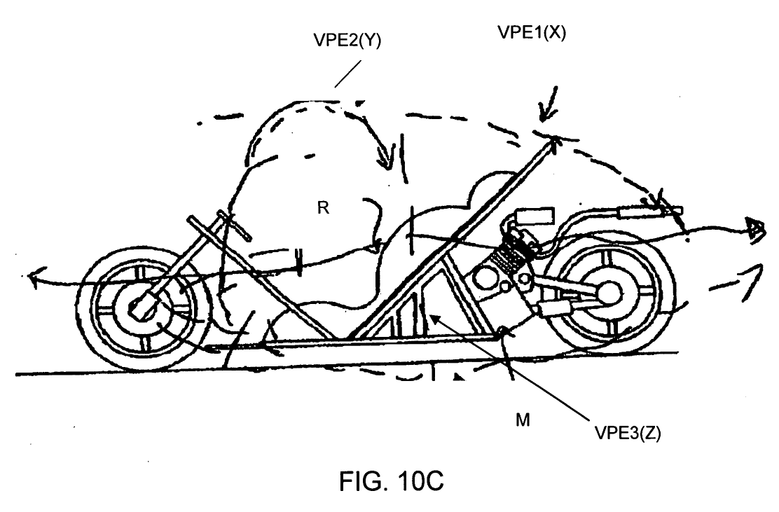

The structures in the first embodiment may create a partial oval frame in at least two parts, creating a virtual “zone of protection” (not shown) for a rider with three “virtual ellipses” (not shown) in six degrees, which are illustrated in a sample implementation in FIGS. 10A-C, which is discussed below.

Referring to FIG. 7, a primary embodiment of the invention (Suprine Machine™ Model #5) includes a rear protective oval structure, RPO1, which generally forms part of the rear part of the frame (not labeled, can be comprised of multiple parts) and which rises at an angle theta prime (Θ′) from the plane formed from the roadway surface. The “axis” of the oval (which may be considered the riding platform structure RP for illustration purposes) rises towards the rear of the vehicle, with the rising part partially forming a riding platform structure RP. The second partial oval structure FPO is generally formed by part of the frame of the front part (not labeled), and is positioned such that the plane of the oval/ellipse is at an angle phi prime (φ′) from the road surface and rising towards the front of the vehicle. Through at least these two protective structures, the rider is located inside a zone of six-degree protection formed by the three virtual ellipses which are created by the two protective ovals OPS1 and FOPS (whereas the first embodiment only creates virtual protective ovals). This can also be illustrated below in FIGS. 10A-C, which are also illustrating the virtual protective ellipse concept shown in FIG. 7 above.

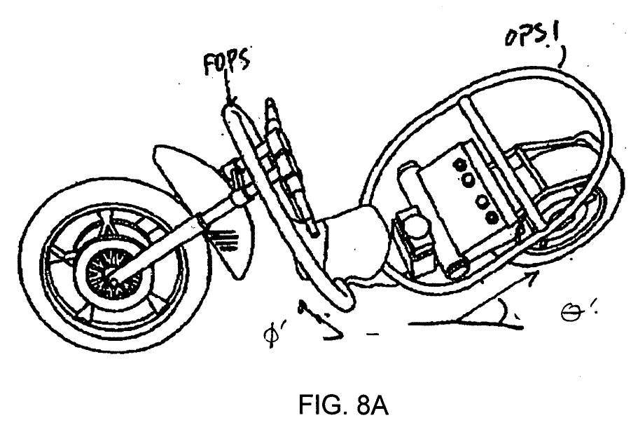

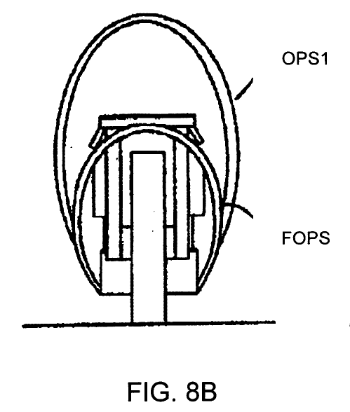

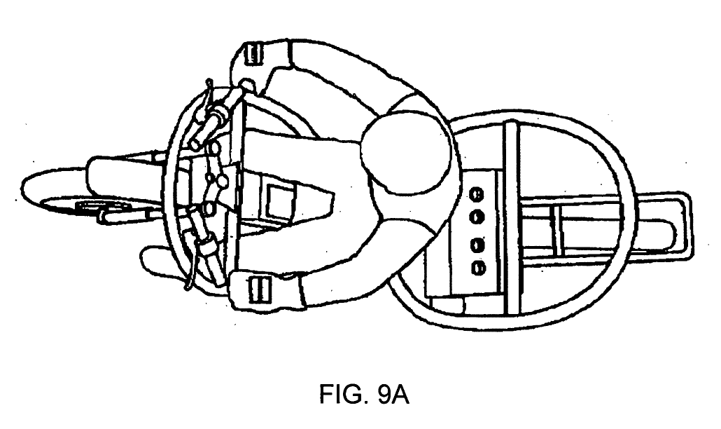

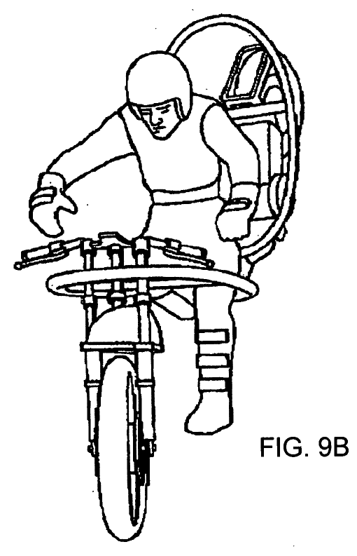

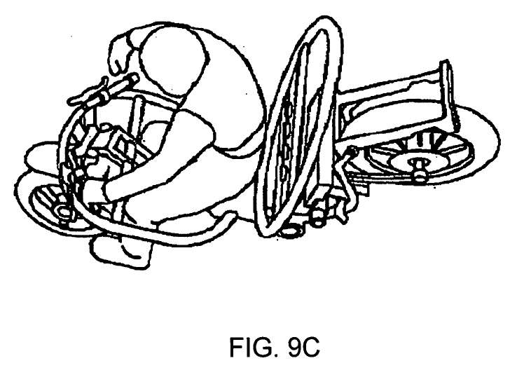

FIGS. 8A and 8B illustrate the primary embodiment from a top and front view without the optional support platform, respectively, and further illustrate the high-performance advantages of the supine cycle as well as the protective advantages.

| Angle Notation (FIG. 9A) | Description |
|---|---|
| ⊖′ | Angle which the riding platform RP and |
| | the oval protection structure is from the |
| | roadway normal. |
| φ′ | Angle at which the first oval protection |
| | structure OPS1 extends out from the z- |
| | axis. |
| [symbol] S′ | Angle at which the riding platform |
| | structure RP intersects the front support |
| | (110′). |
| [symbol] S+′ | Front support (110′) to rear normal |
| | plane. |
| [symbol] S2′ | Front support (110) to front normal |
| | plane. |
| [symbol] S3′ | Steering column (RO) to z axis. |

The partial oval structures OPS1 and FOPS should be made of a high-strength material which may include metals, but also could include high-strength materials that are capable of shock absorption and have flexibility such as, but not limited to Kevlar®, or other carbon-fiber composites. The use of particular materials will depend on whether the dual ellipses OPS1 and FOPS are the primary frame or are supported by an additional support platform SP, which is shown in FIG. 7.

Structural options for various embodiments of the invention include configurations where the rear partial oval formed by the first structure extends above the rider's head, creating the desired protection for the rider, which is also discussed below.

The vehicle is configured such that the rider's feet generally project past the rear-most edge of the front tire to partially straddle the front wheel. The rider R may be secured to said riding platform with a securing structure SS.

The vehicle provides a seating position for the rider in a recumbent, semi-reclining, or supine position, thus improving rider ergonomics and certain aspects of vehicle performance. The recumbent configuration may vary, but can be considered based on the configuration of the cycle's structures forming angles at least: S, S+, S2 and S3 (see table above), but not limited to said angles.

The engine of the preferred embodiment is generally located behind said riding platform. The engine can be supported by a horizontal support located below said engine and structurally attached to the rear part of said frame, or can be integral to the chassis itself as a load-bearing component without additional components.

FIGS. 9A-C further illustrate the protective features of the inventive vehicle from respective top-rear, top-front and overhead views with a sample rider in place. FIG. 9A further illustrates the preferred embodiment of the invention which is a two-wheeled motor-propelled vehicle where the rider is positioned inside the three virtual ellipses, discussed above. These ellipses are usually formed by the two (at least) partial oval structures which are generally made of desirable high-strength material, suitable for providing rider protection. The material may be a metal or a carbon-fiber material, but should provide a small amount of flexibility to provide the rider R with additional protection in an accident.

Once again, as described in FIG. 2 above, an optional gyroscopic balancing system (not shown) can be used with the preferred embodiment in order to assist the driver during slow speed and while stopped. The specifics of the gyroscopic system necessary to assist the rider vary from embodiment to embodiment and must consider such factors as, inter alia, the weight of the bike, the position of the rider, the center of gravity of the bike, velocity and particular tilt.

Referring now to FIGS. 10A-C, a “functional view” of the zones of protection in the primary embodiment using the “double ellipse” type frame (or as an added feature to another embodiment) for a sample rider in the primary embodiment of the invention (or Model #5) is illustrated. FIG. 10A illustrates the zone of protection functions and a sample of protection in degrees x+/x− for an end-over-end type of accident/collision.

FIG. 10B illustrates the oval protective structure embodiment (Model #5) from a second or frontal view and demonstrates how the two oval protective structures OPS1 and FOPS protect the rider in a rollover accident situation. FIG. 10B illustrates the y-degree protection, which is most important in both major and minor motorcycle accidents of the “rollover” or “sliding” type.

FIG. 10C shows a functional top view of the first embodiment as it would be protective of the rider in a more unlikely end-over-end type of collision, in which the rider would normally be “thrown.”

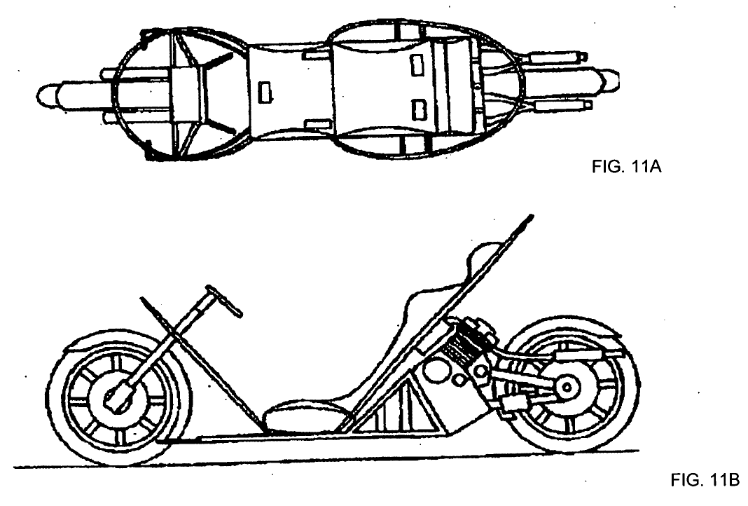

Particular rider-inspired features may be provided in various embodiments of the inventive cycle and need not correspond to any “level” of rider protection shown in the different embodiments described above. For example, the bucket seat may be used with the oval frame model (or Suprine Machine™ model #6) as shown from top and side views in FIGS. 11A and 11B, respectively. Thus, it should be appreciated by those skilled in the art, that end-use demand for comfort, performance, and safety parts of the invention may be “mixed and matched” as demanded by the market without departing from the spirit and scope of the invention. The bucket seat BS sits on the optional support platform SP, while the rider R sits at the recline angle, which is the same as angle S, as shown in FIG. 7.

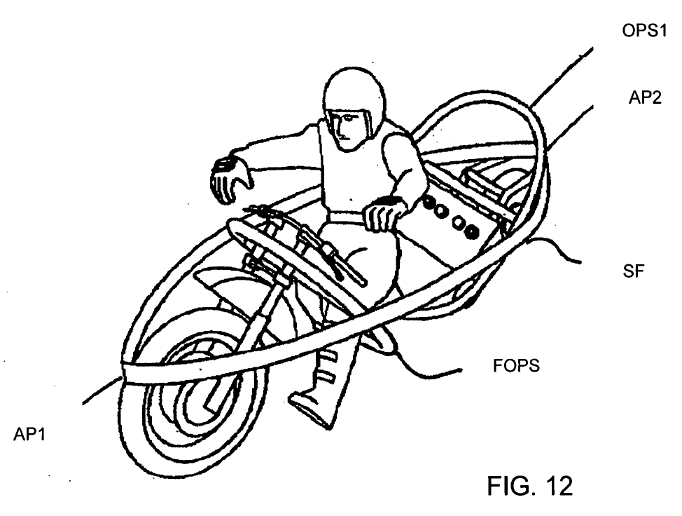

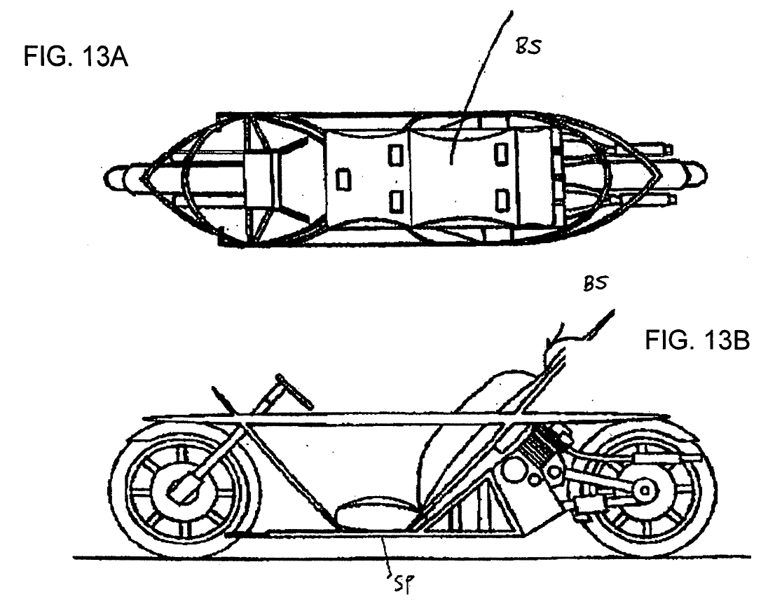

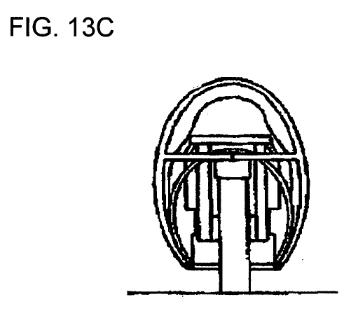

Referring now to FIGS. 12-13C, another alternate embodiment, the combination of oval frame and side frames (or Suprine Machine™ model #7), is illustrated. The protective functions of the oval frames OPS1 and FOPS are discussed above in embodiments discussed in FIGS. 7-11B; however, an additional side frame SF, is shown as an ellipsoid-type structure which meets at aerodynamic points AP1 and AP2 and runs the majority of the length of the vehicle. The side frame SF may provide significant protection for the rider while reducing the cost and strength of materials used in the oval frame protections system OPS1 and FOPS. The balance of performance, cost, and need for rider protection allows the inventive cycle to be made with optional features in which the SF may also serve as support for many rider-oriented features (not shown). This may be more popular in models that are designed for long-distance travel.

The side frame embodiment of the invention may also be combined with high-end rider comfort features, such as the bucket seat model (or Suprine Machine™ model #7 enhanced) shown from the top, side and front views in FIGS. 13A-C, respectively.

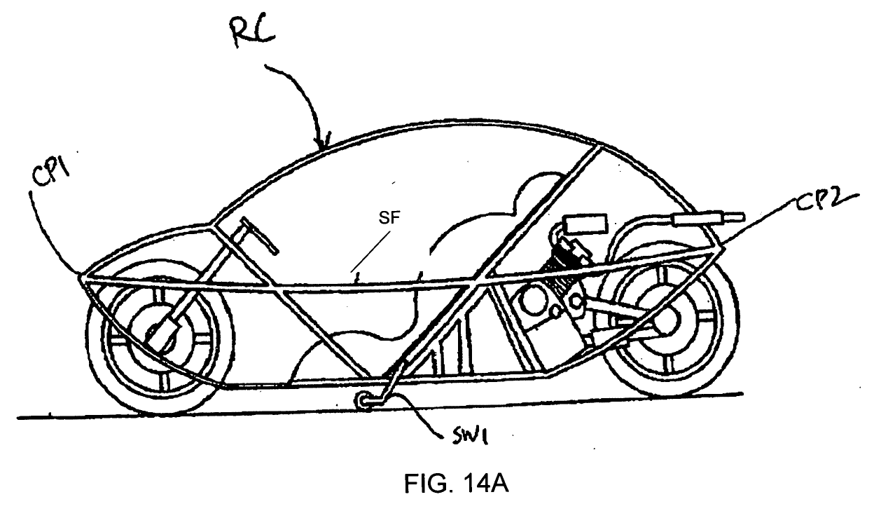

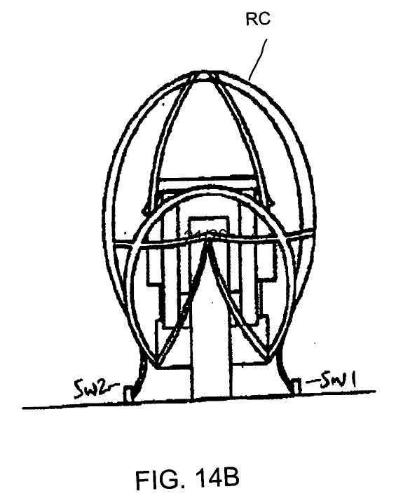

FIGS. 14A and 14B illustrate the rollcage embodiment of the invention (Suprene Machine™ model #8) from side and front views, respectively. The roll cage RC may be configured as shown, such that the rider enjoys six-degrees of protections, without severe limitations of the enjoyment that two-wheeled vehicles can provide. The side frame SF system, discussed above in FIGS. 12, 13-C, may be employed and assembled separately from the roll cage portions RC.

Also shown in the roll cage embodiment in FIGS. 14A and 14B, are the support wheel or arms SW(A) and SW(B) that extend down from the rider platform to help stabilize the two wheeled vehicle during times when it is not in motion. The support arm SW could be easily attached to the bottom portion of the roll cage RC. Optionally, the support wheel/arm SW(A/B) may be retractable or fold into or along the sides or bottom edge of the vehicle.

The advantage of manufacturing the oval protection OPS1, FOPS, the side frame SF and roll cage RC systems as separate components, is that the complexity of the vehicle's protection system may be easily added to in the manufacturing plant or at the dealer location or even by the end-user. It is advantageous to make the contact points CP1 and CP2 easily attachable and securable, and these joints or attachments may have locking systems that allow for the efficient removal of the one of the protective components. As shown in the diagram of FIG. 14A, the lower portion LP of the roll cage RC system can be “integrated” into the riding platform RP for the ease of manufacture and the optional “removable roll cage” feature.

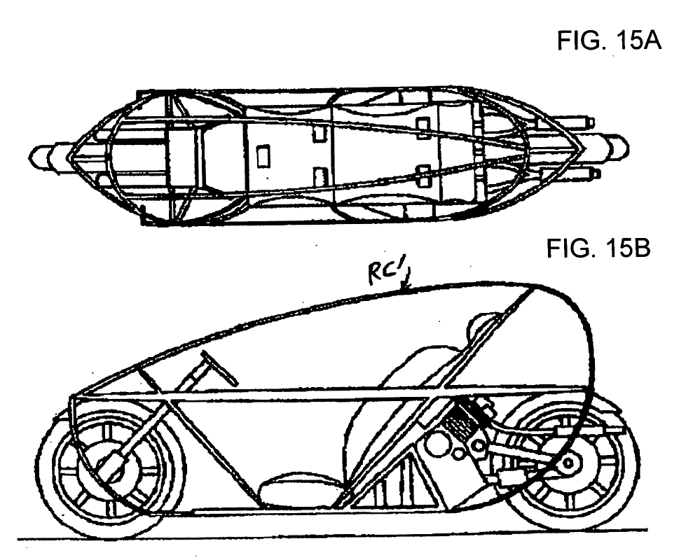

FIGS. 15A and 15B show the top and side view of the roll cage embodiment, which includes a bucket seat feature (Suprine Machine™ model #9). Also shown, is an alternate roll cage shape RC′ in which the shape of an uneven ellipse (towards the rear end of the cycle) may provide aerodynamic advantages. The bucket seat feature does not need to be combined with the alternate roll cage RC′, but is shown together for the sake of economy.

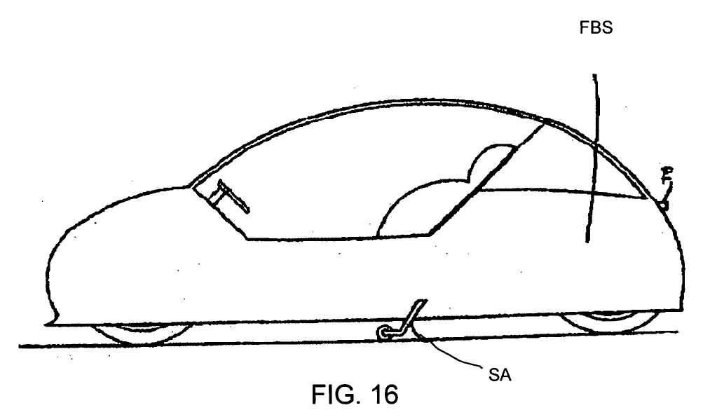

FIG. 16 illustrates the full body protection system embodiment (MiPod™ or Suprine Machine™ model #10), where a strong material forms a lightweight and aerodynamic body FBS without compromising many of the advantages that make two-wheeled vehicles popular.

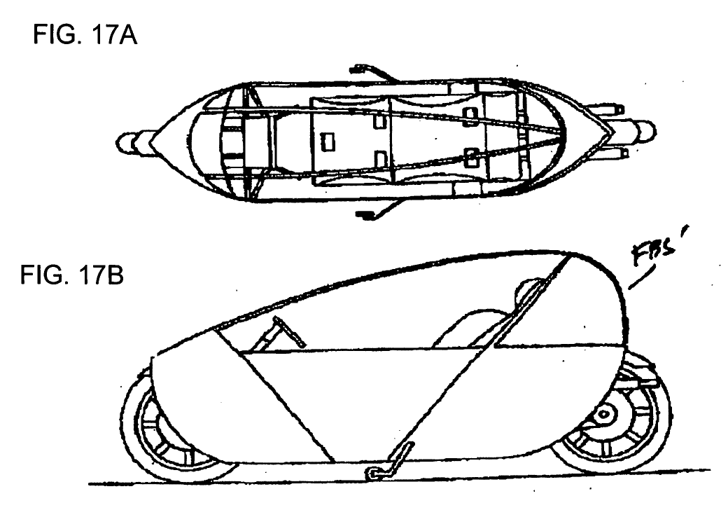

FIGS. 17A and B show top and side views of the full body protection system, known by the Tradename MiPod™, in which a diagonal spine structure DSS is also employed for support, and an alternate shape is used in the full body protection FBS′ much like the alternate shape, provided by the alternate roll cage shape shown in FIGS. 15A and B.

The various embodiments can include optional structures and configurations which include: an electric or hybrid design; a transversely mounted “V” engine; a transversely mounted inline multi-cylinder engine, or a flat horizontally-opposed multi-cylinder engine; the vertical cylinder plane of a transversely-mounted engine can be rotated rearward to minimize and create a more compact engine-transmission-drive wheel configuration which minimizes the overall wheelbase.

The chassis may consist of a single backbone longitudinal member connecting the front forks and the rear engine, but other structures are also possible as shown in the illustrations.

In another alternate design, the chassis may consist of a complete roll cage of interconnected members to fully encapsulate the driver.

In one configuration, an envelope body nearly completely surrounding the vehicle and driver can be provided to protect the driver and decrease wind resistance. In one such configuration, the envelope body does not extend past either the front or rear wheels in order to enable the wheels to serve as bumpers. One alternate embodiment of the invention includes outboard side support arms which may be extended to provide balance when the vehicle is not in motion. The optional outboard side support arms may have smaller secondary wheels to provide balance when the vehicle is operating at low speeds. The outboard side support arms may be controlled by mechanically applied leverage controlled by the driver. One option allows outboard side supports that are electronically controlled based on gyroscopic sensors. Another optional embodiment has the outboard side supports with smaller secondary wheels that are electronically controlled with gyroscopic sensors.

Other optional configurations include the following: the backbone spine is comprised of multiple elements to provide a matrix structure; the backbone spine projects up from the floor-pan of the vehicle to connect to the front wheel forks; the backbone spine projects up to the front wheel forks which then extends between the legs of the rider; the seat is a full “bucket” seat with base and back; the chassis is partially enclosed by a front windscreen to provide better airflow; the chassis is partially enclosed by a lower extended fender/firewall to protect the legs of the rider from road elements including such as rain; portions of the envelope body are segmented and hinged to provide access to the rider; portions of the envelope body are segmented and hinged to provide access to selected portions of the interior for storage; and the envelope body extends to cover the entire front and rear wheels for optimum airflow.

The above-discussed optional features, as well as other optional configurations for various embodiments of the invention, may be implemented without departing from the scope and spirit of the invention. While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which, is to be given the full breadth of the claims appended and any and all equivalents thereof.

What is claimed is:

1. A two-wheeled motor-propelled vehicle with the driver positioned in a recumbent position with the engine located behind the rider, both at a minimal height above ground for sufficient roadway clearance, in which a steering system for said vehicle is comprised of a forked column and a chassis for said motor-propelled vehicle extends down from said forked column towards a rider seat.

2. The two-wheeled vehicle as recited in claim 1 wherein additional chassis components provide mounting points for impact-resistant members.

3. (canceled)

4. The two-wheeled vehicle as recited in claim 1, further including a gyroscopic balancing system.

5. The two-wheeled vehicle as recited in claim 4, wherein said gyroscopic balancing system is located underneath a rider.

6. The two-wheeled vehicle as recited in claim 4, wherein said gyroscopic balancing system is positioned vertically.

7. The two-wheeled vehicle as recited in claim 4, wherein said gyroscopic balancing system is positioned across three axes.

8. (canceled)

9. A two-wheeled motor-propelled vehicle having an engine and a riding platform in which a rider is positioned inside two ellipses that form a virtual zone of protection in six degrees comprising:
at least two at least partial oval structures forming the virtual ellipse,
said first at least partial oval structures being formed by part of the rear part of the frame of said vehicle and is positioned such that the plane of the oval is at an angle theta to the roadway surface, and rises towards the rear of said vehicle,
and axis of said first partial oval rises towards the rear of said vehicle;
said rising part at least partially forms a riding platform structure; and
said second at least partial oval structure formed by part of the frame of the front part of said vehicle, and is positioned such that the plane of the oval is at an angle phi, parallel to the road surface and rising towards the front of said vehicle;

10. The two-wheeled propelled vehicle as recited in claim 9, whereby the rider is located inside the zone of protection created by the three virtual ellipses.

11. The vehicle as recited in claim 9, wherein the at least partial oval structures are made of high-strength material;

12. The two-wheeled vehicle as recited in claim 9, wherein said at least partial oval formed by said first structure extends above the rider's head.

13. The two-wheeled vehicle as recited in claim 9, wherein said engine is located behind the rider.

14. The two-wheeled vehicle as recited in claim 13, wherein said engine is supported by a horizontal support located below said engine and structurally attached to the rear part of said frame.

15. The two-wheeled vehicle as recited in claim 13, wherein said engine is a structural component of the chassis supported the rear suspension and other essential elements of the vehicle.

16. (canceled)

17. The two-wheeled vehicle as recited in claim 9, wherein said high-strength material is selected at least one carbon-fiber based material, or combination thereof.

18-19. (canceled)

20. The two-wheeled vehicle as recited in claim 9, wherein said second structure forms at least two of said virtual ellipses.

21. The two-wheeled vehicle as recited in claim 9, wherein said first structure forms at least two of said virtual ellipses.

22. The two-wheeled vehicle as recited in claim 9, wherein said first structure and said second structure form at least one of said virtual ellipses individually and form at least one of said virtual ellipses collectively.

23-69. (canceled)

70. A two-wheeled motorized vehicle in which a steering column for a front wheel is suspended by a frame in which a diagonal-shaped member extends down from said steering column to a support platform, said support platform directly supporting a rider seat and a riding platform, said riding platform angling upward and away from said diagonal-shaped member and said support platform, said riding platform being for supporting the back of a rider, wherein an engine mount extends from the top of said riding platform to the rear end of said support platform, wherein said engine is located underneath said riding platform and entirely in front of a rear wheel.

71-72. (canceled)

73. The two-wheeled vehicle as recited in claim 70, further comprising a gyroscopic balancing system.

74. The two-wheeled vehicle as recited in claim 73, wherein said gyroscopic balancing system is located beneath said rider.

75-80. (canceled)
